(19) United States
(12) Patent Application Publication
(10) Pub. No.: US 2004/0123289 A1
(43) Pub. Date: Jun. 24, 2004

(54) Multi-processing inside a virtual machine

(76) Inventor: Paul C. Drews, Gaston, OR (US)

Correspondence Address: Timothy N. Trop, TROP, PRUNER & HU, P.C., STE 100, 8554 KATY FWY, HOUSTON, TX, 77024-1841, US

(21) Appl. No.: 10/326,624

(22) Filed: Dec. 20, 2002

(51) Int. Cl. G06F 9/00

(52) U.S. Cl. 718/1

(57) ABSTRACT

A technique includes providing a virtual machine and creating multiple processes within the virtual machine. Each process is associated with a different program.

### BACKGROUND

The invention generally relates to multi-processing inside a virtual machine.

Many programming languages ultimately result in the compilation of source code directly into machine code that is executable on a particular microprocessor architecture. However, some programming languages, such as JAVA®, are executable on a virtual machine. In this manner, a “virtual machine” is an abstract specification of a processor so that special machine code (called “bytecodes”) may be used to develop programs for execution on the virtual machine. Various emulation techniques are used to implement the abstract processor specification including, but not restricted to, interpretation of the bytecodes or translation of the bytecodes into equivalent instruction sequences for an actual processor. Due to these techniques, program code to be executed by the virtual machine may be written independently of the actual hardware on which the program code is executed.

In a typical computer system, an operating system may establish a particular instance of a virtual machine in response to a request to execute a program written for the virtual machine. The operating system creates a new instance for each request to execute a program written for the virtual machine. Thus, it is typically common for many instances to be present and managed at one time by the operating system.

The difficulty with this arrangement is that the multiple instances of the virtual machine may produce a significant amount of overhead for the operating system and substantial duplication of function, consuming a significant amount of system resources.

Thus, there is a continuing need for better ways to manage the execution environment for programs written for virtual machines.

### BRIEF DESCRIPTION OF THE DRAWING

FIG. 1 is a flow diagram depicting a technique used by an execution environment according to an embodiment of the invention.

FIG. 2 is an illustration of a software architecture according to an embodiment of the invention.

FIG. 3 is a block diagram of a portable computing or communication device according to an embodiment of the invention.

FIG. 4 is a flow diagram depicting a technique for multi-processing according to an embodiment of the invention.

### DETAILED DESCRIPTION

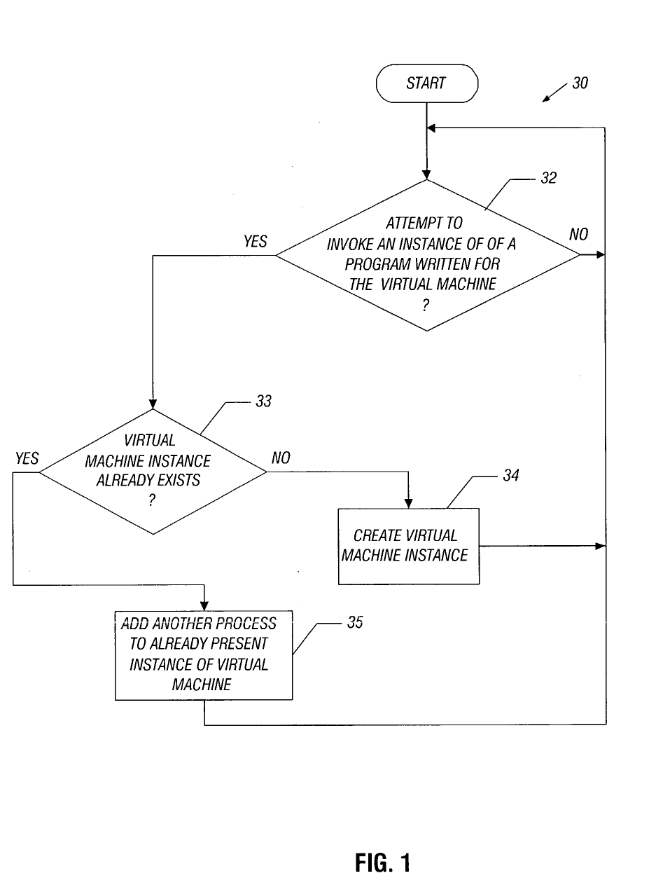

A software architecture in accordance with an embodiment of the invention may perform a technique 30 that is depicted in a flowchart in FIG. 1. Instead of creating a separate instance of a virtual machine (a JAVA® virtual machine, a NET virtual machine, etc.) in the operating system environment every time an execution environment attempts to invoke an instance of a program written for the virtual machine, the software architecture, in accordance with embodiments of the invention, establishes an associated process inside a sole instance of the virtual machine. Therefore, in accordance with the technique 30, in some embodiments of the invention, the technique 30 includes determining (diamond 32) whether there is an attempt to invoke an instance of a program written for the virtual machine. If so and if a virtual machine instance already exists (diamond 33), then another process is added (block 35) under the control of the already existing instance of the virtual machine. Otherwise, an instance of the virtual machine is created, as depicted in block 34.

Therefore, regardless of the number of program instances that routines attempt to invoke, only one virtual machine instance is created and maintained by the operating system. Thus, each program instance adds another process for the sole instance of the virtual machine to control.

Any execution environment that allows dynamic invocation of program instances includes some software that makes requests to invoke those program instances. Interactive systems typically include overall control programs such as command-line “shells” or graphical “desktops” to invoke program instances on behalf of user requests. Executing programs themselves may act as overall control programs, that is, they may invoke additional program instances. Automated systems typically include overall control programs to invoke programs in response to “scripts” or receipt of external commands or signals. Any such overall control program may itself require a substantial amount of system software support such as Graphical User Interface libraries, memory management, file system, etc.

In some embodiments of the invention, all such overall control programs can be written to execute in the virtual machine. In these embodiments, much of the support that is usually the responsibility of an operating system can be removed. In particular, in some embodiments of the invention, at least support for a Graphical User Interface (GUI); the multi-processing responsibility and capability; the separation and context-switching of address spaces between processes; the creation and destruction of process contexts; the tracking and arbitration of resource ownership (such as files and devices) to processes; and the maintenance of memory heaps for processes may be moved to the virtual machine itself. Most virtual machines already supply such capabilities; therefore the removal of these responsibilities from the operating system results in substantially reduced duplication and substantially reduced system overhead.

Thus, in accordance with the invention, any request to invoke a program to run in the virtual machine communicates with the sole instance of the virtual machine (if one already exists) to create a process inside the virtual machine for execution of the virtual machine program. Therefore, instead of the operating system managing the executions of multiple instances of the virtual machine to allow simultaneous executions of multiple virtual machine programs, a sole instance of the virtual machine manages multiple processes, each of which is associated with one of the virtual machine programs.

In some embodiments of the invention, the virtual machine may be a JAVA® (virtual machine (as an example) that includes an infrastructure for threading; and strong control of addresses and pointers in the processes that are created by the virtual machine. In accordance with the invention, an overall control program communicates with the sole instance of the virtual machine (if one already exists) to create a process that is managed by the virtual machine to manage execution of the virtual machine program. Conventionally, a virtual machine program may create multiple processes inside a particular virtual machine. Here, a particular virtual machine program may do the same by creating subprocesses (in the virtual machine) that are associated with the particular process that is associated with the virtual machine program.

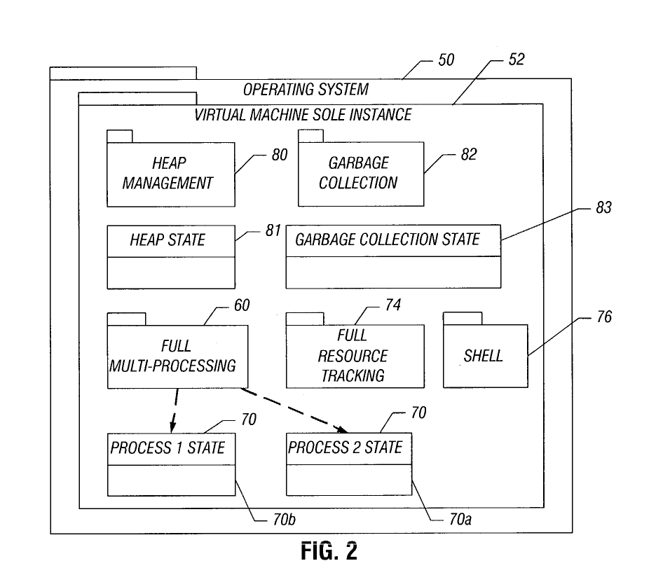

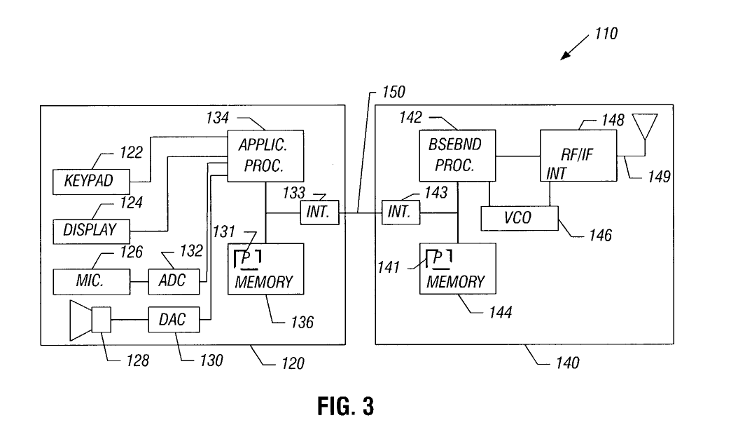

Referring to FIG. 2, in some embodiments of the invention, an operating system 50 or an overall control program may create a sole instance 52 of the virtual machine and thereafter use this instance 52 for purposes of executing multiple processes 70, each of which is associated with and established by a call to invoke a virtual machine program. Likewise, when a call is made to close a particular instance of a virtual machine program, the operating system 50 or an overall control program informs the virtual machine instance 52 to cause the instance 52 to close the appropriate process 70. As an example, processes 70a and 70b are illustrated in FIG. 3, each of which was created in response to a software call to invoke an instance of a virtual machine program.

Also depicted in FIG. 2 are the components of the instance 52 of the virtual machine, such as a heap management component 80. The heap management component 80 manages the active resources of the instance 52 and maintains the states of these resources in a heap state 81. Furthermore, the virtual machine instance 52 includes a garbage collection component 82. This garbage collection component 82 takes care of freeing dynamically allocated memory that is no longer referenced and maintains the state of garbage collection in a garbage collection state 83. If not for the consolidation of the virtual machine instances into a single instance 52 that has multiple processes 70, each virtual machine instance may include a heap management component 80 and a garbage collection component 82, along with their associated states 81 and 83. Furthermore, these resources could be redundant or replicated in multiple instances of the virtual machine. Here, the resources are consolidated and conserved.

Additionally, in the virtual machine instance 52 depicted in FIG. 2 includes a multi-processing component 60 that manages the execution of the processes 70 and each processes different threads. Furthermore, a resource tracking component 74 manages the resources for these processes 70. Additionally, the instance 52 may include a shell component 76 or other overall control program that manages the creation of the processes 70.

Due to the conservation of resources and the reduction of redundancy, the above-described software architecture may be used in a system that does not have ample real memory, virtual memory and operating system capabilities. For example, in some embodiments of the invention, the above-described architecture may be used in a portable computing or communication device 110 (herein called “a portable device”) that is depicted in FIG. 3.

Referring to FIG. 3, in some embodiments of the invention, the portable device 110 may be a one-way pager, a two-way pager, a personal communication system (PCS), a personal digital assistant (PDA), a cellular telephone, a portable computer, etc. Furthermore, the portable device 110 may include an application subsystem 120 and a communication subsystem 140.

As an example, the application subsystem 120 may provide features and capabilities that are visible and/or used by a user of the device 110. For example, the application subsystem 120 may be used for purposes of email, calendaring, audio, video, gaming, etc. The communication subsystem 140 may be used for purposes of providing wireless and/or wired communication with other networks, such as cellular networks, wireless local area networks, etc.

As a more specific example, in some embodiments of the invention, the application subsystem 120 may include an application processor 134 that is coupled to a memory 136. As an example, the memory 136 may be a flash memory or a dynamic random access memory (DRAM), as just a few examples. Stored within the memory 136 may be a program code 131 that stores, for example, all or part of an operating system for the application subsystem 120, program code to invoke an instance of a virtual machine program, etc.

As a more specific example, for the case in which the portable communication device 110 is a cellular telephone, the application subsystem 120 may provide an interface to the user of the cellular telephone and thus, provide a keypad 122 which may be used to enter instructions and telephone numbers into the cellular telephone. The application subsystem 120 may also include a display 124 for displaying command options, caller information, telephone numbers, etc.

Furthermore, the application subsystem 120 may include a microphone 126 for sensing commands and/or voice data from the user. The microphone 126, thus, may provide an analog signal indicative of a voice signal, and this voice signal may be converted into a digital format by an analog-to-digital converter (ADC) 132. The digital data from the ADC 132, in turn, may be provided to the application processor 134. Likewise, data from the keypad 122 may also be provided to the application processor 134. Graphical data to be viewed by the user of the cellular telephone may be provided to the application processor 134 to the display 124.

Among the other features of the application subsystem 120, in some embodiments of the invention, the application subsystem 120 may include a speaker 128 that receives an analog signal from a digital-to-analog converter (DAC) 130 that, in turn, receives digital data from the application processor 134. For example, the speaker 128 may be used to provide a ringing signal to the user, for the case in which the device 110 is a cellular telephone, as well as providing audio data that is provided by a cellular network or other network, for example.

In some embodiments of the invention, the application processor 134 may include one or more microcontrollers or microprocessors, such as a Pentium microprocessor, for example.

In some embodiments of the invention, the communication subsystem 140 may include a baseband processor 142 (a digital signal processing DSP) engine, for example) that establishes a particular communication standard for the portable communication device 110. The baseband processor 142 may be coupled to a radio frequency/intermediate frequency (RF/IF) interface 148 that forms an analog interface for communicating with an antenna 149 of the device 110. Furthermore, the communication subsystem 140 may include a voltage controlled oscillator (VCO) 146 that supplies the appropriate frequencies for modulation, demodulation to the interface 148, and these frequencies may be controlled by the baseband processor 142, in some embodiments of the invention.

Among the other features of the communication subsystem 140, in some embodiments of the invention, the subsystem 140 may include a memory 144 (a DRAM memory or a flash memory, as a few examples) that is coupled to the baseband processor 142. The memory 144 may store program instructions and/or data. As an example, in some embodiments of the invention, the memory 144 may store program code 141 for purposes of establishing the operating system, the virtual machine, etc., to implement the techniques described herein.

In some embodiments of the invention, the communication subsystem 140 may communicate with the application subsystem 120 via a communication link 150. In this manner, the link 150 may span between an interface 133 of the application subsystem 120 and an interface 143 of the communication subsystem 140 for purposes of communicating data between these two subsystems.

Other embodiments are within the scope of the following claims. For example, the systems described above may have user interfaces. However, in some embodiments of the invention, the techniques described herein may be applied to an embedded system or another system that may have a limited capacity that does not permit a user interface. Thus, the techniques described herein may apply to non-interactive systems as well.

As another example, in some embodiments of the invention, instead of the execution environment (such as an operating system, for example) determining whether an instance of the virtual machine has already been invoked (i.e., pursuant to diamond 33 (FIG. 1) of the technique 30), the virtual machine itself may determine, when the virtual machine is invoked, whether another instance of the virtual machine has been invoked. If so, the virtual machine forwards the invocation request to the other instance, and subsequently the virtual machine terminates itself.

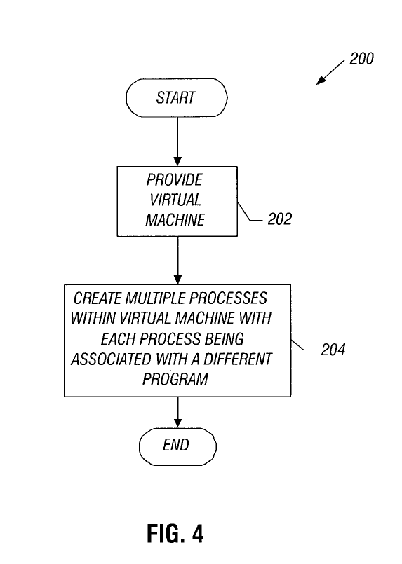

As yet another example of another embodiment of the invention, the request to invoke a particular program written for a virtual machine may come from within the virtual machine itself. In this manner, one of the processes being managed by the virtual machine may invoke another program that is also written for the virtual machine. However, instead of another instance of a virtual machine being created, the virtual machine creates another process. Thus, regardless of the entity calling a particular program written by a virtual machine, in accordance with the invention, the multi-processing for different programs is managed by a virtual machine. Referring to FIG. 4, thus, in accordance with the invention, a technique 200 includes providing (block 202) a virtual machine and creating (block 204) multiple processes within the virtual machine. Each of these processes is associated with a different program.

The combination of the techniques described covers a substantial portion of the functionality ordinarily required from an operating system in the absence of this invention. A consequence of building systems in accordance with this invention is that an operating system with very limited capabilities, and therefore a very small size, can be used. The smaller size may be reflected in the form of a variety of different benefits such as lower system physical size, cost, power consumption, etc.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
providing a virtual machine; and
creating multiple processes within the virtual machine, each of the multiple processes being associated with a different program.

2. The method of claim 1, further comprising:
creating at least one of the processes in response to a request to invoke one of the programs created by another one of the processes.

3. The method of claim 1, further comprising:
creating at least one of the processes in response to a request to invoke one of the programs by another process not existing within the virtual machine.

4. The method of claim 1, further comprising:
creating at least one of the processes in response to a request to invoke another instance of the virtual machine.

5. The method of claim 4, further comprising:
not invoking another instance of the virtual machine in response to the request.

6. The method of claim 4, wherein the request originates from one of processes within the virtual machine.

7. The method of claim 4, wherein the request originates from a process outside of the virtual machine.

8. A system comprising:
a flash memory storing instructions; and
a processor coupled to the flash memory to execute at least some of the instructions to provide a virtual machine and create multiple processes within the virtual machine, each of the multiple processes being associated with a different program.

9. The system of claim 8, wherein the processor creates at least one of the processes in response to a request to invoke one of the programs created by another one of the processes.

10. The system of claim 8, wherein the processor creates at least one of the processes in response to a request to invoke one of the programs by another process not existing within the virtual machine.

11. The system of claim 8, wherein the processor creates at least one of the processes in response to a request to invoke another instance of the virtual machine.

12. The system of claim 8, wherein the system comprises at least one of a portable computing device and a portable communication device.

13. A system comprising:
a memory storing instructions; and
a processor to execute at least some of the instructions to provide a virtual machine and create multiple processes within the virtual machine, each of the multiple processes being associated with a different program.

14. The system of claim 13, wherein the processor creates at least one of the processes in response to a request to invoke one of the programs created by another one of the processes.

15. The system of claim 13, wherein the processor creates at least one of the processes in response to a request to invoke one of the programs by another process not existing within the virtual machine.

16. The system of claim 13, wherein the processor creates at least one of the processes in response to a request to invoke another instance of the virtual machine.

17. The system of claim 13, wherein the system comprises at least one of a portable computing device and a portable communication device.

18. An article comprising a computer readable storage medium storing instructions to cause a processor to:
provide a virtual machine, and
create multiple processes within the virtual machine, each of the multiple processes being associated with a different program.

19. The article of claim 18, wherein the storage medium stores instructions to cause the processor to:
create at least one of the processes in response to a request to invoke one of the programs created by another one of the processes.

20. The article of claim 18, wherein the storage medium stores instructions to cause the processor to:
create at least one of the processes in response to a request to invoke one of the programs by another process not existing within the virtual machine.

21. The article of claim 18, wherein the storage medium comprises instructions to cause the processor to:
create at least one of the processes in response to a request to invoke another instance of the virtual machine.

22. The article of claim 21, wherein the storage medium stores instructions to cause the processor to:
not invoke another instance of the virtual machine in response to the request.

23. The article of claim 21, wherein the request originates from one of the processes within the virtual machine.

24. The article of claim 21, wherein the request originates from a process outside of the virtual machine.
